(19) United States
(12) Patent Application Publication
(10) Pub. No.: US 2024/0316988 A1
(43) Pub. Date: Sep. 26, 2024

(54) LOW WEIGHT FLANGED INNER RING OF A WHEEL HUB UNIT

(71) Applicant: AKTIEBOLAGET SKF, GOTEBORG (SE)

(72) Inventors: Marco ROMANETTO, Pianezza (IT); Marco GEMELLO, Nichelino (IT); Thomas NIESTROJ, Würzburg (DE); Santosh Ashok GHATTI, Bangalore (IN)

(21) Appl. No.: 18/607,776

(22) Filed: Mar. 18, 2024

(30) Foreign Application Priority Data
Mar. 22, 2023 (IT) 102023000005433

(51) Int. Cl. B60B 27/02

(52) U.S. Cl. CPC B60B 27/02; B60B 2310/208; B60B 2900/111; B60B 2900/112; B60B 2900/113; B60B 2900/50

(57) ABSTRACT

A flanged inner ring of a wheel hub unit includes a flange extending transverse to a central axis of symmetry and having a plurality of fixing holes for attaching a wheel. The flanged inner ring also includes a continuous tubular body projecting axially from the flange, the continuous tubular body having a plurality of polygonal recesses. The polygonal recesses reduce weight of the wheel hub unit and improve water drainage from the wheel hub unit.

### CROSS-REFERENCE

This application claims priority to Italian patent application no. 102023000005433 filed on Mar. 22, 2023, the contents of which are fully incorporated herein by reference.

### BACKGROUND OF THE INVENTION

The present invention relates to bearings, and more particularly to wheel hub bearing units for vehicles.

Hub bearing units or wheel hub units are designed for automotive and industrial applications to provide pre-adjusted clearance or preload. In automotive applications, the wheel hub unit is located between a brake disc and the drive axle. The wheel hub units support the vehicle weight and also transmits the driving force from the engine to the wheel.

A standard design of a wheel hub unit is shown in FIG. 1A. Referring to FIG. 1A, a wheel hub unit 120a includes a flanged inner ring 105a. The flanged inner ring 105a includes a flange 110a. The flange 110a includes a continuous tubular body 115a projecting axially from the flange 110a and radially bounded by a cylindrical outer mounting surface 125a. The standard design wheel hub unit 120a does not provide adequate water drainage. It is also desired to have overall weight reduction of the wheel hub unit 120a.

An improved design of the wheel hub unit is shown in FIG. 1B. Referring to FIG. 1B, a wheel hub unit 120b includes a flanged inner ring 105b. The flanged inner ring 105b includes a flange 110b. The flange 110b includes a continuous tubular body 115b projecting axially from the flange 110b and radially bounded by a cylindrical outer mounting surface having polygonal forged shape 125b. The wheel hub unit 120b provides some weight reduction and better water drainage. However, it is desired to have a wheel hub unit with lesser weight and improved water drainage.

### SUMMARY OF THE INVENTION

An objective of the present invention is to provide an improved design of a flanged inner ring in a wheel hub unit to reduce weight of the wheel hub unit and to improve water drainage from the wheel hub unit.

Accordingly, a flanged inner ring of a wheel hub unit is disclosed. The flanged inner ring comprises a flange transverse to an axis X of symmetry and include a plurality of fixing holes for attaching a wheel. The flanged inner ring comprises a continuous tubular body projecting axially from the flange. The continuous tubular body comprises a plurality of polygonal recesses. The polygonal recesses reduce weight of the wheel hub unit and improves water drainage in the wheel hub unit.

### BRIEF DESCRIPTION OF THE SEVERAL VIEWS OF THE DRAWINGS

The invention will now be described with reference to the attached drawings which show some non-limiting examples of embodiment thereof in which:

FIG. 1A is a perspective view of a prior art standard design of a wheel hub unit;

FIG. 1B is a perspective view of a prior art improved design of a wheel hub unit;

FIG. 2 is a perspective view of a wheel hub unit in accordance with an embodiment of the present invention; and

FIG. 3 is a broken-away, axial cross-sectional view of the wheel hub unit of the present invention, depicting water drainage from the wheel hub unit.

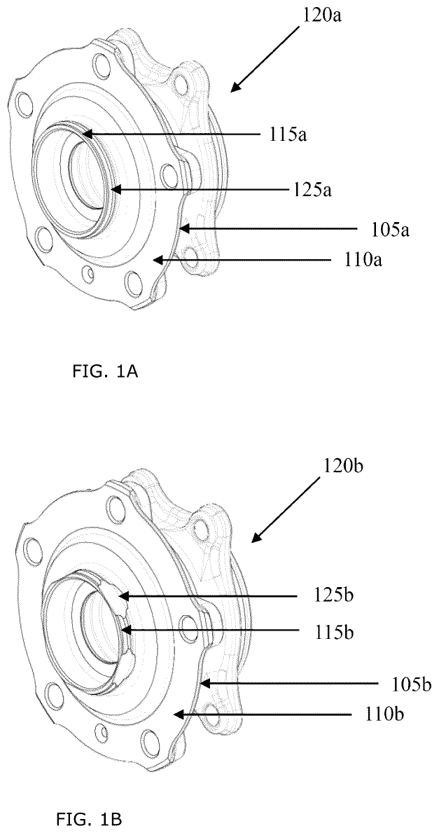

### DETAILED DESCRIPTION OF THE INVENTION

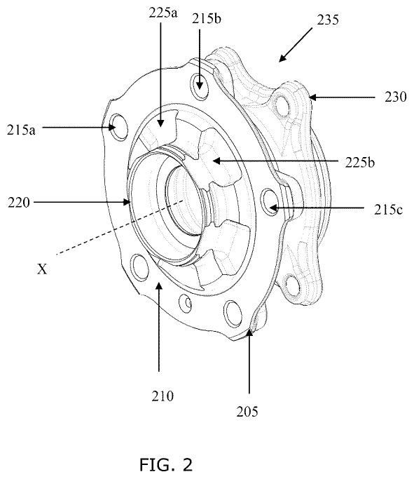

FIG. 2 depicts a wheel hub unit 235 in accordance with an embodiment of the present invention. The wheel hub unit 235 includes a flanged inner ring 205. The flanged inner ring includes a flange 210 extending transverse to a central axis X of symmetry and includes a plurality of fixing holes 215a, 215b, 215c . . . for attaching a wheel spaced circumferentially about the central axis X. It must be noted that there are more than three holes 215a, 215b, 215c . . . shown in FIG. 2.

The flanged inner ring 205 includes a continuous tubular body 220 projecting axially from the flange 210. The continuous tubular body 220 includes a plurality of polygonal recesses 225a, 225b . . . or grooves spaced circumferentially about the central axis X. More specifically, the tubular body 220 has an axial end integrally formed with the flange 210 and an opposing, free axial end, and the polygonal recesses 225a, 225b . . . are formed at the junction between the tubular body 220 and the flange 210. The polygonal recesses 225a, 225b . . . or grooves are preferably formed in a forging process. It must be noted that there are more than two recesses 225a, 225b . . . shown in FIG. 2.

The polygonal recesses or grooves are formed on unloaded or non-loaded flange areas of the flanged inner ring 205. The unloaded or non-loaded areas correspond to flange surface areas located between the holes 215a, 215b, 215c . . . . For example, the polygonal recess 225a corresponds to a flange surface area between the pair of adjacent holes 215a and 215b and the polygonal recess 225b corresponds to a flange area between the pair of adjacent holes 215b and 215c.

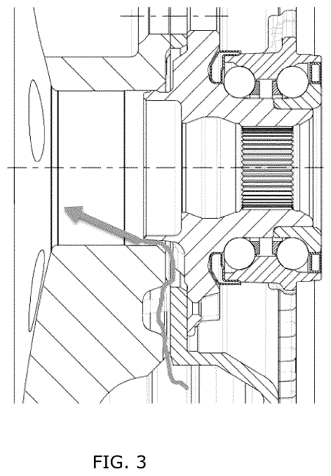

The flange 210 is configured to retain a wheel rim (not shown) to the wheel hub unit 235. The wheel hub unit 235 further includes an outer ring 230 disposed about the flanged inner ring 205. In one embodiment, the outer ring 230 may be flanged. Further, a plurality of rolling bodies (not indicated) are positioned between the flanged inner ring 205 and the outer ring 230 so as to rotatably couple the rings 205, 230, as shown in FIG. 3.

The polygonal recesses 225a, 225b in the flanged inner ring 205 reduce the weight of the wheel hub unit 235. By removing material in the non-loaded part of the flange 210, weight is reduced without degrading the structural strength or integrity of the wheel hub unit 235.

The polygonal recesses 225a, 225b in the flanged inner ring 205 also improve water drainage from the wheel hub unit 235. FIG. 3 depicts water drainage from the wheel hub unit 235, a drainage path from the wheel hub unit being indicated by an arrow, in accordance with an embodiment of the present invention.

The following are some of the main benefits of the wheel hub unit 235 with the flanged inner ring 205:
weight reduction.
improved water drainage due to increased space for drainage between a rim, a brake disk, the flange of the inner ring 205 and a spigot.
cost reduction due to less forging material.
ease of manufacturing.

In addition to the embodiments of the invention, as described above, it is to be understood that numerous further variants exist. It must also be understood that said embodiments are only examples and do not limit either the scope of the invention, nor its applications, nor its possible configurations. On the contrary, although the description provided above enables the person skilled in the art to implement the present invention at least in one of its examples of configuration, it must be understood that numerous variations of the components described are feasible, without thereby departing from the scope of the invention, as defined in the accompanying claims, interpreted literally and/or in accordance with their legal equivalents.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A flanged inner ring of a wheel hub unit, the flanged inner ring comprising:
a flange extending transverse to a central axis of symmetry and comprising a plurality of fixing holes for attaching a wheel; and
a continuous tubular body projecting axially from the flange and having a plurality of polygonal recesses.

2. The flanged inner ring as recited in claim 1, wherein each one of the polygonal recesses correspond to a flange surface area between a separate pair of adjacent fixing holes.

3. The flanged inner ring as recited in claim 1, wherein the tubular body has an axial end integrally formed with the flange and an opposing, free axial end, the polygonal recesses being formed at a junction between the tubular body and the flange.

4. The flanged inner ring as recited in claim 1, wherein the plurality of polygonal recesses are formed in a forging process.

5. The flanged inner ring as recited in claim 1, wherein the flange is configured to retain a wheel rim to a wheel hub.

6. The flanged inner ring as recited in claim 1, wherein the wheel hub unit comprises an outer ring.

7. The flanged inner ring as recited in claim 1, wherein the plurality of polygonal recesses in the flanged inner ring are provided to reduce weight of the wheel hub unit.

8. The flanged inner ring as recited in claim 1, wherein the plurality of polygonal recesses in the flanged inner ring are configured to improve water drainage from the wheel hub unit.

9. A wheel hub unit comprising:
a flanged inner ring having a central axis and including a flange extending transverse to the central axis, the flange having a plurality of fixing holes for attaching a wheel and being spaced circumferentially about the central axis, and a continuous tubular body projecting axially from the flange and having a plurality of polygonal recesses spaced circumferentially about the central axis.

10. The wheel hub unit as recited in claim 9, wherein each one of the polygonal recesses is formed in a flange surface area located circumferentially between a separate pair of adjacent fixing holes.

11. The wheel hub unit as recited in claim 9, wherein the tubular body has an axial end integrally formed with the flange and an opposing, free axial end, the polygonal recesses being formed at a junction between the tubular body and the flange.

12. The wheel hub unit as recited in claim 9, wherein the plurality of polygonal recesses are formed in a forging process.

13. The wheel hub unit as recited in claim 9, wherein the flange is configured to retain a wheel rim to a wheel hub.

14. The wheel hub unit as recited in claim 9, wherein the wheel hub unit further comprises an outer ring disposed about the flanged inner ring.

15. The wheel hub unit as recited in claim 9, wherein the plurality of polygonal recesses in the flanged inner ring are provided to reduce weight of the wheel hub unit.

16. The wheel hub unit as recited in claim 9, wherein the plurality of polygonal recesses in the flanged inner ring are configured to improve water drainage from the wheel hub unit.
